(19) United States
(12) Patent Application Publication
(10) Pub. No.: US 2007/0148438 A1
(43) Pub. Date: Jun. 28, 2007

(54) Fuser roller and method of manufacture

(75) Inventors: Jerry A. Pickering, Hilton, NY (US); Xin Jin, Pittsford, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 11/315,828

(22) Filed: Dec. 22, 2005

(51) Int. Cl. B32B 27/20; G03G 15/20

(52) U.S. Cl. 428/327; 399/333; 428/421

(57) ABSTRACT

The present invention is a coating for a fuser roller having an elastomer layer that includes fluoroplasfic particles dispersed through the elastomer layer wherein the surface of the particles has been contacted with a solution comprising a group I or a group II metal hydride while being exposed to ultraviolet UV radiation. This treatment reduces the fluorine content in of the layer by at least 20 percent and increases the oxygen content or nitrogen content on the layer to greater than zero.

### FIELD OF THE INVENTION

The present invention relates to fuser rollers and treatment of fluoroparticulate materials used therein.

### BACKGROUND OF THE INVENTION

The present invention relates to electrostatographic imaging and recording apparatus, and to assemblies in these apparatus for fixing toner to the substrates. The present invention relates particularly to fuser members, and fusing surface layers for fuser members, in the toner fixing assemblies.

Generally in electrostatographic reproduction, the original to be copied is rendered in the form of a latent electrostatic image on a photosensitive member. This latent image is made visible by the application of electrically charged toner.

The toner forming the image is transferred to a substrate, also referred to in the art as a “receiver”, such as paper or transparent film, and fixed or fused to the substrate. Where heat softenable toners, for example, thermoplastic polymeric binders, are employed, the usual method of fixing the toner to the substrate involves applying heat to the toner once it is on the substrate surface, to soften it and then allowing or causing the toner to cool. This application of heat in the fusing process is at a preferred temperature of about 90° C.-220° C.; pressure may be employed in conjunction with the heat.

A system or assembly for providing the requisite heat and pressure is generally provided as a fusing subsystem, and customarily includes a fuser member and a support member. The various members that comprise the fusing subsystem are considered to be fusing members; of these, the fuser member is the particular member that contacts the toner to be fused by the fusing subsystem. The heat energy employed in the fusing process is generally transmitted to toner on the substrate by the fuser member. Specifically, the fuser member is heated to transfer heat energy to toner situated on a surface of the substrate. The fuser member contacts this toner, and correspondingly also can contact this surface of the substrate itself. The support member contacts an opposing surface of the substrate.

Accordingly, the substrate can be situated or positioned between the fuser and support members so that these members can act together on the substrate to provide the requisite pressure in the fusing process. In cooperating, preferably the fuser and support members define a nip, or contact arc, through which the substrate passes. Preferably, the fuser and support members are in the form of fuser and pressure rollers, respectively. Yet additionally one or both of the fuser and support members have a soft layer that increases the nip to effect better transfer of heat to fuse the toner.

During the fusing process toner can be offset from the substrate to the fuser member. Toner transferred to the fuser member in turn may be passed on to other members in the electrostatographic apparatus or to subsequent substrates subjected to fusing.

Toner on the fusing member, therefore, can interfere with the operation of the electrostatographic apparatus and with the quality of the ultimate product of the electrostatographic process. This offset toner is regarded as contamination of the fuser member thereby improving the release of the fuser member fusing surface layer, and preventing or at least minimizing this contamination is a desirable objective.

Other factors also may disadvantageously affect the fusing member. Heat energy applied to this member can cause its degradation. Degradation can also be effected by continual contact with substrate toner and by toner remaining on the fusing member surface. The fusing member surface can be subjected to abrasion by a variety of sources such as the substrate, for instance, as well as elements of the fusing system, i.e., the support member, release agent applicator, and contact heating members, if these are employed.

These unfavorable effects can result in an uneven fusing member surface and defective patterns in thermally fixed images. Where the substrate employed is paper, abrasion of the fusing member surface at the paper edge can form a worn area, or groove, that becomes problematic when the paper size is changed so that a larger paper overlaps the worn area. When the groove becomes deep enough to affect the fixing of the toner it causes objectionable image defects.

Where high image quality, and/or high image gloss, and/or controlling fusing member surface roughness are required, surface wear and abrasion are particular problems. For instance, if obtaining very high image quality is the objective, even a groove only worn into the surface enough to show a variation in surface gloss will nevertheless generate an objectionable defect in the image. Preventing or minimizing wear accordingly likewise is a desirable objective.

Heavily filled silicone rubber, used for fuser member surfaces, is known to produce high quality fused images. The polysiloxane elastomers have relatively low surface energies and also relatively low mechanical strengths, but are adequately flexible and elastic. Unfortunately, silicone rubbers wear easily when employed for this purpose; after a period of use, the action of the paper or other media passing through a high pressure nip wears a polysiloxane elastomer fuser surface. The silicone rubbers' low wear resistance as fuser member surfaces accordingly limits fuser member life. Further, although treatment with a polysiloxane release fluid during use of the fuser member enhances its ability to release toner, the fluid causes the silicone rubber to swell. This fluid absorption is a particular factor that shortens fuser member life; fluid treated portions tend to swell and wear and degrade faster. Fuser members with polysiloxane elastomer fusing surfaces accordingly have a limited life.

Fluorocarbon materials also have low surface energies, and, like silicone rubbers, are used as release surface materials for fuser members. Polyfluorocarbons employed for this purpose include nonelastomeric fluorocarbon materials, or fluoroplastics, and fluoro-elastomer materials. However, there are disadvantages associated with the use of both.

In fact, the fluorocarbon resins like polytetra-fluoroethylene (PTFE), and copolymers of tetrafluoroethylene (TFE) and perfluoroalkylvinylether (PFA), and fluorinated ethylene propylene copolymers (FEP), have excellent release characteristics due to very low surface energies. They also are characterized by high temperature resistance, excellent resistance to chemical interaction, and low wear (high abrasion resistance).

However, these materials are particularly susceptible to offset, due to high modulus and poor surface contact with rough substrates. Fluorocarbon resins also are less flexible and elastic than polysiloxane elastomers, and are unsuitable for producing high image quality images.

Additionally, fluorocarbon resins, having the indicated typically high modulus, cannot evenly contact rough papers, as noted. Therefore, they provide varying gloss within the same image.

This gloss variation may be referred to as mottled gloss. The poor contact, related (as indicated) to high modulus, also tends to produce images with objectionable offset.

Specifically, with a high modulus there will be objectionable mottled gloss as well as objectionable offset. Contact may be improved by the use of a thin fusing surface layer; however, a surface sleeve is limited to a certain minimum thickness when used in conjunction with an underlying soft cushion, because repeated compression results in sleeve wrinkling.

Fluoroelastomers, besides their low surface energy as indicated, have excellent wear resistance as fusing member surfaces. They provide better durability in this regard than the polysiloxane elastomers, and unlike the silicone rubbers, do not swell when in contact with polysiloxane release fluids.

However, fluoroelastomers have less resistance to chemical interaction than either silicones or fluoroplastics, and must be used in conjunction with reactive release fluids. As release fluids are subject to disruption or failure, fluoroelastomers are always at risk of irreversible contamination.

This is particularly a problem with polyester toners that may contain reactive sites on the toner surface. If the toner encounters the fluoroelastomer surface, the toner may chemically interact with the surface. If this interaction occurs the toner may not be easily removed, and will tend to attract more toner, leading to roller failure.

Inorganic fillers have been incorporated into fluoroelastomer surface layers to achieve the desired combination of properties like wear resistance, modulus, and thermal conductivity. Particularly, it is known that certain fillers may be used to reinforce the elastomer and further enhance the wear resistance of fluoroelastomers.

However, it is also known that the presence of inorganic filler particles, in the fluoroelastomer fusing surface layers of fuser members, provides high-energy sites for removing toner from the substrate. In addition, inorganic fillers are typically extremely hard and abrasive to other elements of the toner fusing system that contact the fuser member.

It is further difficult to provide surface layers which are suitably free of defects, and which in combination with high wear resistance have a sufficiently high gloss, or are otherwise of the requisite degree of smoothness. Particularly, it is difficult to provide surface layers with these desirable properties where the layers are obtained by application of the fluoroelastomer composition in solution, especially where the layers are built up to the desired thickness by applying successive coats.

Considering the foregoing, it would be desirable to provide a fusing member fluoroelastomer surface that retains the indicated advantages of fluoroelastomers, while also minimizing the tendency to acquire irreversible toner contamination. Especially with respect to fillers, it would be desirable that the tendency of the filler to cause toner offset be minimized, while the filler also enhances the wear resistance of the fluoroelastomer; further, it would be desirable to have fillers that do not wear contacting members.

In this regard, it is known to use PTFE as filler for a fusing surface layers. With PTFE and similar fluororesins being recognized as having low adhesion, good chemical resistance, and low coefficients of friction, there have been many attempts to combine these fluororesins with other materials used in fusing surface layers.

For instance, U.S. Pat. Nos. 3,669,707 and 3,795,033 disclose a fuser roller having a silicone elastomer surface that incorporates fluorinated resin filler, such as fibrillatable Teflon powder. U.S. Pat. No. 4,568,275 discloses a fuser roller with a surfacial layer prepared from an aqueous dispersion comprising fluorinated rubber and fluorinated resin. U.S. Pat. No. 5,376,996 discloses a fuser roller with a coating comprising a mixture of polyphenylene sulfide and polytetrafluoroethylene. U.S. Pat. No. 5,547,742 discloses a fuser roller having a surface layer comprising a fluorosilicone rubber and 5 to 50 weight percent of a fluororesin, such as polytetrafluoroethylene.

Further, U.S. Pat. No. 4,503,179 discloses an aqueous fluorine-containing rubber coating composition comprising a fluorine-containing rubber, a fluorine-containing resin, and an aminosilane. U.S. Pat. Nos. 4,555,543 and 5,194,335 disclose a film forming fluid coating or casting composition, comprising fluoroplastic resin dispersion modified by a fluoroelastomer latex.

U.S. Pat. No. 6,239,223 discloses a blended solid composition comprising a fibrillatable microparticulate polytetrafluoroethylene and a fluoroelastomer; also disclosed is a blended solid composition comprising a low molecular weight, nonfibrillatable polytetrafluoroethylene and a fluoroelastomer, wherein the nonfibrillatable polytetrafluoroethylene is present at greater than 35 percent by weight, based on total polymer solids of the composition.

In all of the preceding examples the fluoroplastic is inert and cannot strongly interact with the matrix. Although this does not preclude successful application of fluoroplastic particulates, the adhesion between the particulate and the matrix is weak and this will degrade material properties including wear resistance and tensile properties. Typical surface treatments using silanes, titanates, and the like are ineffective due to the inherent inertness of the fluoroplastic surface.

Enhancement of the bonding of fluororesin films is well known in the art. Fluoropolymer sleeves including PFA and PTFE are etched using a solution of alkali metals dissolved in liquid ammonia to provide a bond with the supporting cushion. These solutions are extremely hazardous and are unsuitable for use with a finely dispersed powder where the extent of surface treatment would be difficult to control and the possibility of hazardous uncontrolled exothermic reaction exists.

Thus, it would be desirable to provide a method for enhancing the surface energy of fluoroplastic powders in a controlled manner.

Surface modification of fluoroplastic powders has been described in U.S. Pat. No. 6,824,872 where a polymeric film is grown around fluoroplastic particles to improve incorporation and bonding into coatings and articles. In this process the surface of fluoropolymer powder is not chemically altered per se but rather the particle is encapsulated.

Thus, it is an object of this invention to provide a fluoroplastic particulate with a surface that has higher surface energy than the bulk of the particulate, and where the bulk of the particulate retains the desirable fluoroplastic character.

It is further an object of this invention to provide a fusing surface layer that is uniform and defect free and that comprises a curable elastomer and a surface treated fluoroplastic particulate that has excellent resistance to paper abrasion and toner offset. It is further an object of this invention to provide a surface layer that can be prepared from a compounded fluoroelastomer composition, and that is suitable for bisphenol type cure systems.

It is further an object of this invention to provide a method for producing a fusing surface layer having the desirable characteristics as indicated. It is further an object of this invention to provide a coating composition for producing a fusing surface layer having the desirable characteristics as indicated.

### SUMMARY OF THE INVENTION

The present invention is a coating for a fuser roller having an elastomer layer that includes fluoroplastic particles dispersed through the elastomer layer wherein the surface of the particles has been contacted with a solution comprising a group I or a group II metal hydride while being exposed to ultraviolet UV radiation. This treatment reduces the fluorine content in of the fluoroplastic particles by at least 20 percent and increases the oxygen content or nitrogen content on the fluoroplastic particles to greater than zero.

### DESCRIPTION OF THE INVENTION

It has been discovered that, with respect particularly to fluoroplastic particulates dispersed into elastomer coatings, and still more particularly, into a curable coating solution; that surface modification of the fluoroplastic particles by solution chemical treatment in the presence of UV light provides improved wear resistant coatings for electrophotographic applications. In a preferred embodiment, the surface modification of the fluoroplastic particles is accomplished by agitation in a solution comprising a group I or a group II metal hydride, group I preferred, and sodium hydride is particularly preferred and a UV absorber, preferably one that forms a reactive excited state, in the presence of UV light provides improved coating wear resistance. It has further been discovered that surface modification of fluoroplastic particles improves their performance in silicone elastomers. Additionally, the release properties of the coating are not degraded.

As to the foregoing, the invention pertains to a layer preferably, a surface layer for an article; the surface layer comprises an elastomer, and further comprises surface modified fluoroplastic particles. Preferably, the particles are dispersed uniformly in the elastomer layer.

Also, as a matter of preference, the layer as indicated is a fusing surface layer and the article is a fuser member. Accordingly, in a particularly preferred embodiment, the invention pertains to a fuser member for a toner fusing system or process, with the fuser member comprising a base and a fusing surface layer, and with this fusing surface layer comprising the layer as indicated.

The fusing surface layer of the invention is characterized by excellent wear and excellent release.

The invention further pertains to a method for treating fluoroplastic particulates. This method comprises dispersing the particulate in a solvent comprising a UV absorber and a group I metal hydride or a group II metal hydride, exposing the solution to UV light through a UV transparent surface, and agitating the solution such that the particles are uniformly treated at the UV transparent surface.

A further advantage of the present invention is that the method of treating the fluoroplastic particles provides a solution that may be used directly in the solvent coating without added steps of separating and drying the particles.

Fusing or operating temperatures, or the temperature of the fusing process, is understood as being within the range of from about 90° C. to about 250° C. The preferred temperatures are generally within the range of from about 120° C. to about 200° C., more preferably from about 150° C. to about 185° C., still more preferably from about 160° C. to about 180° C.

Copolymers are understood as including polymers incorporating two different monomeric units, i.e., bipolymers, as well as polymers incorporating three or more different monomeric units, e.g., terpolymers, quaterpolymers, etc.

Elastomers are understood as including polymers that are nonelastomeric at room temperature but elastomeric at fusing or operating temperatures.

Polyorganosiloxanes are understood as including polydiorganosiloxanes i.e., having two organo groups attached to each of the polymer siloxy repeat units. Polyorganosiloxanes are further understood as including polydimethylsiloxanes.

Functional polyorganosiloxanes are understood as having functional groups on the backbone, connected to the polysiloxane portion, which can react with fillers present on the surface of the fuser member, or with a polymeric fuser member surface layer or component thereof. Functional polyorganosiloxanes further are understood as having functional groups such as amino, hydride, halo (including chloro, bromo, fluoro, and iodo), carboxy, hydroxy, epoxy, isocyanate, thioether, and mercapto functional groups.

The term “organo” as used herein, such as in the context of polyorganosiloxanes, includes hydrocarbyl, which includes “aliphatic”, “cycloaliphatic”, and “aromatic”. The hydrocarbyl groups are understood as including the alkyl, alkenyl, alkynl, cycloalkyl, aryl, aralkyl, and alkaryl groups. Further, “hydrocarbyl” is understood as including both nonsubstituted hydrocarbyl groups, and substituted hydrocarbyl groups, with the latter referring to the hydrocarbyl portion bearing additional substituents, besides the carbon and hydrogen. Preferred organo groups for the polyorganosiloxanes are the alkyl, aryl, and aralkyl groups. Particularly preferred alkyl, aryl, and aralkyl groups are the C₁-C₁₈ alkyl, aryl, and aralkyl groups, particularly the methyl and phenyl groups.

The layer of the invention comprises surface modified fluoroplastic particles. Preferably, the particles are dispersed uniformly in the elastomer layer. Especially, the plastic particles preferably are uniformly, or at least essentially uniformly, dispersed in the layer correspondingly, preferably dispersed uniformly, or at least essentially uniformly, in the elastomer. And further as a matter of preference, this uniform, or at least essentially uniform dispersion is such that surface preparation, surface finishing, wear during use, or other abrasion, results in the same composition at the surface of the layer.

Yet additionally as a matter of preference, the layer of the invention comprises a layer, preferably a surface layer, for a suitable article. The invention accordingly can comprise an article that comprises the indicated surface layer, or an article and a surface layer as indicated for the article, with the indicated surface layer residing on the article.

In a particular embodiment of the invention, the article comprises a fuser member for a toner fusing system or process, and the surface layer comprises a fusing surface layer for the fuser member. In this embodiment the fuser member includes a fuser base, and further includes the fusing surface layer overlaying the fuser base. This fusing surface layer can reside directly on the fuser base. Alternatively, there can be one or more materials and/or layers, including one or more cushion layers, interposed between the fuser base and the fusing surface layer.

Further regarding the fluoroplastic particles of the invention, fluoroplastics include perfluorocarbons, fluorohydrocarbons, and perfluorocarbons containing one or more fluorinated or non-fluorinate monomers. These include PTFE, FEP, and PFA. Fluoroplastics are particularly preferred, as are fluororesins, or nonelastomeric fluorocarbons. Fluororesins that are suitable include polytetrafluoroethylenes (PTFE), and fluorinated ethylene propylenes (FEP), including copolymers of tetrafluoroethylene and hexafluoropropylene, as well as copolymers of tetrafluoroethylene and ethylene, and copolymers of tetrafluoroethylene and perfluoroalkyl vinyl ether (PFA). Suitable fluororesins have a number average molecular weight of from about 1,000 to about 10,000,000.

PTFE particles have low surface energy, and correspondingly a low propensity for removing toner from the substrate. They also do not have the abrasiveness of inorganic filler particles, and therefore do not subject sensors and skives, or other such contacting elements, to wear. Nevertheless, the PTFE particles themselves impart good wear resistance to fusing surface layers.

Polytetrafluoroethylenes including one or more additional monomers in minor amounts, such as up to about 5 mole percent, may be used. Suitable such additional monomers include fluorocarbons, chlorocarbons, hydrofluorocarbons, hydrochlorocarbons, fluoroethers, and hydrofluoroethers, and particularly perfluoroalkylvinylethers. Specific examples are hexafluoropropylene and n-perfluoropropylvinylether.

Particularly preferred polytetrafluoroethylenes, including those comprising one or more additional monomers in minor amounts, such as up to about 5 mole percent are those having a molecular weight of from above about 25,000 to about 250,000. Polytetrafluoroethylenes in this molecular weight range i.e., which can be referred to as low molecular weight (LMW) PTFE are desirable due to their low cost, and their availability in various particle sizes, and dry powder form.

A method for preparing LMW PTFE from higher molecular weight polytetrafluoroethylene is by gamma or electron beam irradiation of the latter, such as disclosed in U.S. Pat. No. 5,846,447 and Great Britain Patent Specification No. 1,354,471, which are incorporated herein in their entireties, by reference thereto. Another method, as discussed herein, is by mechanical shear degradation of the higher molecular weight polytetrafluoroethylene.

Commercially available LMW polytetrafluoroethylenes, which are suitable for the invention, include the following: Zonyl™ MP1100, MP1000, and MP1300, from DuPont Fluoroproducts, Wilmington, Del.; Dyneon™ 9207, from Dyneon L.L.C., Oakdale, Minn.; Algoflon™ FSA EX, from Ausimont USA, Inc., Thorofare, N.J.; and M270 and M290, from Shamrock Technologies Inc., Newark, N.J.

The plastic particles, particularly the PTFE particles of the invention preferably have a mean particle diameter of from about 0.05 microns, or about 0.1 microns, to about 20 microns, or about 30 microns, or about 50 microns or about 80 microns. In the case of fusing surface layers, a factor in determining the size of the plastic particles to be used is the surface roughness that is desired. Smaller particle sizes provide the greatest wear reduction, but also produce a very smooth coating; particularly, small sized particles, such as in the range of about 2 microns, will generate a very high gloss, defect free surface. Larger particle sizes may be used to reduce the coating smoothness, and thus the resulting output image gloss; particles of sufficient size will provide a low gloss surface.

For application where a smooth surface is desired, the particle size is preferred to be between about 0.1 and 25 microns, more preferably about 0.1 to 18 microns, still more preferably between about 0.1 and 12 microns. Where a rough surface is desired, the particle size is preferred to be between about 12 microns and 80 microns, more preferably between about 18 and 60 microns, and more preferably between about 25 and 60 microns.

The fluoroplastic particles may be in one or more of any suitable shapes irregular, as well as in the form of spheroids, platelets, flakes, powders, ovoids, needles, fibers, clusters, and the like.

The fluoroplastic particles are dispersed into an elastomer. Elastomers that are useful in the present invention include silicone elastomers, fluorosilicone elastomers, fluorocarbonelastomers, perfluoroelastomers, and perfluoropolyether elastomers.

The plastic particles can comprise at from about 5 percent by volume to about 70 percent by volume, of the layer of the invention.

The layer of the invention can comprise at least about 8 parts to about 300 parts, of plastic particles per 100 parts by weight elastomer.

Particularly with respect to fluoroelastomers, increasing the proportion of the PTFE particles in the fusing surface layer of the invention results in greater offset resistance for the layer. Resistance to wear also is improved as the proportion of this PTFE increases, up to and including the range of about 150 parts to about 200 parts per 100 parts by weight fluoroelastomer, and the range of about 43 percent by volume to about 62 percent by volume, and the range of about 40 percent by weight to about 66 percent by weight, this latter range being based upon the combined weight as indicated; within these ranges, the highest levels of wear resistance are achieved.

There have been many attempts to combine these fluororesin particulates with other materials in fusing surface layers due to the low adhesion, good chemical resistance, and low coefficients of friction of the materials. However, all of the preceding examples the fluoroplastic is inert and cannot strongly interact with the matrix. The adhesion between the particulate and the matrix is weak and this will degrade material properties including wear resistance and tensile properties. Typical surface treatments using silanes, titanates, and the like are ineffective due to the inherent inertness of the fluoroplastic surface.

It is desirable to modify the fluororesin particulate surface to make it more compatible with the matrix materials, but without damaging the bulk properties of the fluoropolymer fillers. Surface treatments of fluoropolymer films are known in prior art. Those treatments include alkali metal solution chemical treatment, electrolytic reduction process, corona discharge, flame treatment and plasma treatment. J. Polymer Science, Polymer Chemistry Ed. 35, 1499 (1997) reported fluoropolymer films were surface treated in a benzophenone and sodium hydride solution with ultra-violet (UV) irradiation. The UV excited state of either diphenyl ketyl radical anion or benzhydrol anion from the reaction of benzophenone and sodium hydride chemically modifies the fluoropolymer film surface.

Although there are various methods for the surface treatment of fluoropolymers, majority of them are surface treatment of polymer films or sheets. The surface treatment of fluoropolymer particles is not trivial. The UV assisted chemical modification is preferred for large scale of surface treatment of industrial application. However, the excited state either diphenyl ketyl radical anion or benzhydrol anion is found to have short lifetime. The surface treatment of fluoropolymer films indicates only the surface exposed directly to the UV irradiation was modified. A uniform modification of fluoropolymer particle surface is a challenge.

In the present invention the particles are dispersed in a fluid with sufficient agitation to insure that the particles are contacting the treatment zone and are treated in a uniform manner. The process may be a batch process, a semi-batch process, or a continuous process. The extent of treatment is controlled by the average resident time of a particle, which may be determined by engineering calculations for fluid residence times of stirred tank reactors, tubular flow reactors, etc. which are well known in the art.

The treatment zone is generally very close to the fluid surface due to absorption of the UV and the short lifetime of the anion thus, the particles must have intimate contact with the surface and the surface area maximized to high yields. A preferred reaction surface is a UV transparent material such as quartz in direct contact with the fluid containing the dispersed particles.

In one embodiment, a photochemical reactor from Ace Glass, equipped with a medium pressure, quartz, mercury-vapor ultraviolet immersion lamp from Hanovia, was employed for the fluoropolymer particle modification. The surface area of the reactor exposed to the immersion lamp in the center of reactor is larger than general UV arc lamp. Hence, the treatment efficiency of the fluoropolymer particles by the immersion lamp is improved.

The treatment solution comprises a group I or group II metal hydride dispersed in the fluid with the particles. Group I metal hydrides, for example lithium, sodium, and potassium are preferred; and sodium hydride is particularly preferred. The metal hydride is preferably a powder for easy dispersal in the fluid and so as to remain suspended in the solution. Smaller particle sizes are preferred to larger sizes, these being more easily dispersed, remaining suspended with less agitation, and having a greater surface area for the reaction. A particularly preferred particle size is less than 10 microns mean particle diameter.

The treatment solution further comprises a UV absorber, preferably one that forms a reactive excited state in the presence of UV light. Suitable UV absorbers include type II photoinitiators such as benzophenones, thioxanthones, and their derivatives. Other UV absorbers include benzoin ethers, benzil ketals, acylphosphine oxides, dialkoxy acetophenones, amino alkylphenones and other aromatic ketone derivatives.

Suitable solvents of the treatment solution have low absorption in the range of the UV wavelengths used. Solvent without triple bonds, double bonds, or heavy atoms are preferred. Particularly preferred are solvents with good solubility of benzophenone, including DMF and MEK. More particularly preferred are solvents also having good solubility of the layer elastomer, for example MEK when fluoroelastomers are employed. In such solvents, the treated solution requires minimal separation and does not require drying of the treated particles prior to addition to a coating solution for preparation of the layer of the invention. Solvents should also be relatively stable to strong bases such as CaOH, NaOH, and KOH as these may be generated during the reaction.

It is also desirable to minimize the presence of water and oxygen in the treatment solution. In this aspect the treatment solution is preferably free, or essentially free, of water and oxygen.

In one embodiment of the invention, a mixture of benzophenone, sodium hydride, fluoropolymer particles and dispersion media are severely purged with nitrogen to make the suspension turbulent. The turbulent state makes the fluoropolymer particles flow freely in the suspension so that the particle surface is exposed to the UV source uniformly.

The surface-treated fluoropolymer particle by UV irradiation is typically a uniformly brownish powder, while the untreated particles are white. The wettability of the treated particles is significantly improved in water and organic solvents. Analysis of X-ray Photoelectron Spectroscopy (XPS) indicates that the treated fluoropolymer particles have reduced fluorine, increased carbon, incorporation of oxygen and nitrogen. The incorporation of oxygen and nitrogen functional groups provides potential binding sites with other materials of the fusing layer formulations so as to improve the overall mechanical properties. In addition, XPS results show the modification of the fluoropolymer particles is almost exclusively within 4-10 nm from the surface and the bulk part of the particles is not changed.

For improving the wear resistance and release properties of the fusing surface layer, one or more of the materials which are used for preparing the fusing surface layer, and which are reactive with SiOH groups, may be compounded with a coupling agent, preferably a silane coupling agent, as discussed in U.S. Pat. No. 5,998,033. Materials suitable for this treatment include treated fluoroplastic particles, inorganic fillers, and cocuratives.

As to this matter, herein it is disclosed that the materials that are compounded, for subsequent combination with solvent and formation of the fusing surface layer, include the fluoroelastomer. Where the layer also incorporates inorganic particles, they as well are included in the dry compounding treatment. And if additional inorganic filler and cocurative are being employed, they also may be included in this treatment. Accordingly, where one or more SiOH group-reactive materials, as indicated, are present, the requisite amount of coupling agent yet additionally can be included in the compounding of these materials.

Instead of compounding with coupling agent, one or more of the SiOH group-reactive materials may be surface treated with a coupling agent here also preferably a silane coupling agent, as discussed in U.S. Pat. Nos. 5,935,712; 6,090,491 and 6,114,041. The coupling agent can be dissolved in an appropriate solvent, and surface treatment can be affected by steeping the material in this solution; ultrasonication can be employed during this treatment. After treatment the material is washed and dried. In the case of silane, preferably the treatment solution is prepared by adding about 2 weight percent of this coupling agent to a solvent comprising 95 percent by volume ethanol and 5 percent by volume acidified water, and stirring for ten minutes. The material is covered by the solution and ultrasonicated for ten minutes. The material then is separated by vacuum filtration, rinsed with ethanol, and thereafter oven dried at 150° C., for 18 hours under reduced pressure (vacuum).

It is understood that both the surface treatment and the compounding, as discussed, are included in referring to treatment with coupling agent. It is further understood that both material compounded with silane coupling agent, and material surface treated with silane coupling agent, are included in referring to the resulting product as silane coupling agent-treated material.

Particularly, the silane coupling agents for fluoroelastomer layers, 3-aminopropyltriethoxysilane is a silane which may be employed. However, the secondary amine functional silanes are preferred, because they have relatively less of an unfavorable impact upon pot life. Suitable secondary amine functional silanes include N-phenylaminopropyltrimethoxysilane, N-phenylaminopropyltriethoxysilane, 3-[2-N-benzylaminoethylaminopropyltri-methoxysilane, and 3-[2-N-benzylaminoethylaminopropyltri-ethoxysilane. Also among the silanes that may be used are the styryl-functionalized silane coupling agents disclosed in U.S. Pat. No. 6,090,491.

U.S. Pat. Nos. 5,998,033; 5,935,712; 6,090,491, and 6,114,041 are incorporated herein in their entireties, by reference thereto.

The surface treated fluoroplastic particulate is also suitable for surface treatment with the aforementioned coupling agents.

Treatment with chemical coupling agents may be employed immediately after washing the UV-treated fluoroplastic particles, or after the UV-treated fluoroplastic particles have been separated and dried. Silane coupling agents may also be added directly to the coating solution. Suitable coupling agents include the aforementioned silane coupling agents.

Suitable fluoroelastomers for the fusing surface layer include random polymers comprising two or more monomeric units, with these monomeric units comprising members selected from a group consisting of vinylidene fluoride [—(CH2CF2)—], hexafluoropropylene [(CF2CF(CF3))—], tetra-fluoroethylene [—(CF2CF2)—], perfluorovinylmethyl ether [—(CF2CF(OCF3))—], and ethylene [—(CH2CH2)—]. Among the fluoroelastomers that may be used are fluoroelastomer copolymers comprising vinylidene fluoride and hexafluoropropylene, and terpolymers as well as tetra and higher polymers including vinylidene fluoride, hexafluoropropylene, and tetrafluoroethylene monomeric units. Additional suitable monomers include perfluorovinylalkyl ethers, such as perfluorovinylmethyl ether.

Preferred fluoroelastomers include random polymers comprising the following monomeric units:
—(CH2CF2)x-, —(CF2CF(CF3))y-, and —(CF2CF2)z-,
wherein
x is from about 30 to about 90 mole percent,
y is from about 10 to about 60 mole percent, and
z is from about 0 to about 42 mole percent.

Further preferred fluoroelastomers are random polymers comprising the following monomeric units:
—(CH2CH2)x-, —(CF2CF(OCF3))y-, and —(CF2CF2)z-,
wherein
x is from about 0 to about 70 mole percent,
y is from about 10 to about 60 mole percent, and
z is from about 30 to about 90 mole percent

The fluoroelastomers, as discussed, may further include one or more cure site monomers. Among the suitable cure site monomers is 4-bromoperfluorobutene-1, 1,1-dihydro-4-bromo-perfluorobutene-1, 3-bromoperfluorobutene-1, and 1,1-dihydro-3-bromoperfluoropropene-1. When present, cure site monomers are generally in very small molar proportions. Preferably, the amount of cure site monomer will not exceed about 5 mole percent of the polymer.

The fluoroelastomer molecular weight is largely a matter of convenience, and is not critical to the invention. However, as a matter of preference, the fluoroelastomers have a number average molecular weight of from about 10,000 to about 200,000. More preferably they have a number average molecular weight of from about 50,000 to about 100,000.

Among the fluoroelastomers that may be used are those that are plastic at ambient temperature and elastomeric at fusing or operating temperatures.

Commercially available fluoroelastomers which may be used are those sold under the trademark Viton™ by Dupont Dow Elastomers, Stow, Ohio. Also suitable are the Tecnoflons™ from Ausimont USA, Inc., Thorofare, N.J., and the Fluorel™ fluoroelastomers from Dyneon L.L.C., Oakdale, Minn. Aflas and Fluorel II.

Appropriate fluoroelastomers include those as identified in U.S. Pat. Nos. 4,372,246; 5,017,432; 5,217,837, and 5,332,641. These four patents are incorporated herein in their entireties, by reference thereto.

The Viton™ A, Viton™ GF, FE5840Q, and FX9038 fluoro-elastomers are particularly preferred.

Suitable silicone elastomers include thermally conductive silicone elastomers and thermally nonconductive silicone elastomers. Addition cure, condensation cure, and peroxide cure silicone elastomers can all be used, with addition cure silicone elastomers and condensation cure silicone elastomers being preferred.

Further, silicone elastomers formulated as room temperature vulcanizate (RTV), liquid injection moldable (LIM), and high temperature vulcanizate (HTV) silicone elastomers can be used. RTV and LIM silicones are preferred.

Silicone elastomers are preferably polydimethylsiloxane, poly(dimethyldiphenyl)siloxane, and polymethyl-3,3,3-trifluoropropylsiloxane. The polydimethylsiloxane elastomers are particularly preferred.

Particularly, among the silicone elastomers that may be used are vinyl addition cure silicone elastomers, condensation cure silicone elastomers, and peroxide cure silicone elastomers. Of these, the polyorganosiloxane elastomers are preferred, and the polydimethylsiloxane elastomers are especially preferred. Further, of the vinyl addition cure silicone elastomers, condensation cure silicone elastomers, and peroxide cure silicone elastomers, the vinyl addition cure silicone elastomers and the condensation cure silicone elastomers are preferred.

A vinyl addition cure silicone elastomer that may be used is Silastic™ J silicone, from Dow Corning Corporation, Midland, Mich. This is a room temperature vulcanizate (RTV) silicone elastomer, and has a 60 Shore A durometer. A condensation cure silicone elastomer that may be used is LS4340-103 silicone, from Emerson & Cuming ICI, Billerica, Mass.; this is a RTV silicone elastomer, and has a 20 Shore A durometer. A condensation cure silicone elastomer composition that may be used is EC4952, also from Emerson & Cuming ICI, which has a 65 Shore A durometer, and comprises 64 percent by volume Al₂O₃, 0.8 percent by volume Fe₂O₃, and the remainder condensation cure RTV silicone elastomer. These three commercially available compositions are suitable as elastomers for the present invention.

The fusing surface layer therefore may further include in addition to the surface modified fluoroplastic particulates one or more additional fillers dispersed through the elastomer. Different fillers may be used for such purposes as conducting heat, improving toner offset and release properties of the fusing surface layer, controlling material properties such as wear resistance and surface roughness, modifying hardness, and imparting other characteristics, such as desired mechanical properties, to the fusing surface layer; among the fillers which may be included are reinforcing fillers even though, as indicated, it is preferred that these in particular not be used.

Additional fillers that are suitable include inorganic fillers, such as SnO₂, SiC, CuO, ZnO, Al₂O₃, FeO, Fe₂O₃, WC, BN, TiO₂, and SiO₂. Suitable SiO₂ includes amorphous silica, such as precipitated silica and fumed silica, as well as crystalline silica (quartz).

Thermally conductive fillers may be employed. Suitable thermally conductive fillers include the indicated SnO₂, SiC, CuO, ZnO, FeO, Fe₂O₃, BN, crystalline SiO₂, TiO₂, and Al₂O₃. Preferred thermally conductive fillers are Al₂O₃ and Fe₂O₃.

These additional fillers may be present i.e., dispersed through the elastomer in amounts and proportions, and sizes, as are generally known or as can be determined without undue experimentation by those of ordinary skill in the art. Where present, filler as indicated thermally conductive filler in particular preferably comprises not more than about 45 percent by volume, more preferably not more than about 35 percent by volume, still more preferably not more than about 30 percent by volume of the fusing surface layer. Still more preferably, filler as indicated comprises from about 5 percent by volume, or from about 10 percent by volume, to about 45 percent by volume, of the fusing surface layer.

The one or more fillers may be in one or more of any suitable shapes irregular, as well as in the form of spheroids, platelets, flakes, powders, ovoids, needles, fibers, and the like. For thermally conductive filler, and particularly where such filler is used and internal heating is employed, an irregular shape is more preferred, as are spherical particles and platelets, so as to maximize the heat conducting effect of the filler particles; fibers, needles, and otherwise elongated shapes are less preferred here, unless they are advantageously oriented, because in certain alignments they are less effective for properly conducting heat.

In this regard, elongated thermally conductive particles are more efficient for conducting heat in the proper direction if they are at right angles to the fuser base radially aligned, if the fuser base is a cylindrical core, belt on rollers, or a core-mounted plate, but less efficient if they are positioned parallel to the core axially aligned, if the fuser base is a core, a belt, or is core mounted as indicated. Accordingly, to maximize heat conducting properties where elongated thermally conductive particles are employed, perpendicular (radial) positioning is preferred, while parallel (axial) alignment may be employed but is not preferred.

Particularly as to sizes, preferably these one or more fillers have a mean particle diameter of from about 0.1 microns, or about 0.2 microns, to about 20 microns, or about 50 microns, or about 80 microns.

Yet other additives and adjuvants also may be included in the fusing surface layer, as long as they do not affect the integrity thereof, or significantly interfere with an activity intended to occur in the layer such as elastomer crosslinking. These further additives and adjuvants, where present, are provided in amounts and proportions as are generally known or as can be determined without undue experimentation by those of ordinary skill in the art. Suitable examples include crosslinking agents, processing aids, accelerators, polymerization initiators, and coloring agents.

Particularly with respect to the toner fusing system and the toner fusing process and correspondingly the fuser member of the invention, the fuser base may be any of those as are known in the art. As a suitable embodiment, the fuser base may be a core in the form of a cylinder or a cylindrical roller, particularly a hollow cylindrical roller. In this embodiment the fuser base may be made of any suitable metal, such as aluminum, anodized aluminum, steel, nickel, copper, and the like. Also appropriate are ceramic materials and polymeric materials, such as rigid thermoplastics, and thermoset resins with or without fiber enforcement. Preferably the roller is an aluminum tube or a flame sprayed aluminum coated steel tube.

Alternatively, the fuser base may be a plate. Materials suitable for the core may also be used for the plate.

One embodiment of a fuser base in the plate form is a curved plate mounted on a larger cylindrical roller that is, larger than a cylindrical roller which itself is employed as a fuser core. Being curved, the plate has the shape of a portion of a cylinder. Additionally, the plate can be mounted on the cylindrical roller, so that the plate can be replaced without also requiring replacement of the roller. In this embodiment, the properties discussed herein with reference to the fuser base pertain only to the portion of the cylindrical roller occupied by the attached plate; the rest of this roller is not involved in the fusing of toner to substrate.

In another alternative, the fuser base may be a belt, particularly an endless flexible belt. A thin belt made of a suitable metal, such as those indicated for the core and plate forms; the belt may also be made of a polyamide or a polyimide, particularly a heat resistant polyamide or polyimide. A polyimide material appropriate for the belt is commercially available under the trademark Kapton, from DuPont High Performance Films, Circleville, Ohio.

Preferably the belt is mounted on rollers, which can be cores of the type as discussed herein. As a matter of preference two rollers are utilized with the belt, each of these two rollers defining a different one of the curves around which the belt passes.

A support member for the fusing system and process may be any of those as are known in the art; particularly, it can be a backup roller, also referred to as a pressure roller. The support member can be in the form of a roller, plate, or belt, in the same manner as is suitable for the fuser base; particularly, cores suitable for the fuser member may also be used for the support member. Where the support member is a belt, preferably it is mounted on rollers, in the same manner as for the fuser base in the form of a belt.

In any of the indicated forms, the support member may have mounted thereon a cushion for forming the nip with the fuser member. Suitable cushion materials include those having at least some degree of temperature resistance, such as silicone and EPDM elastomers. In the absence of yet a further layer in turn being mounted on the cushion, this cushion also serves to contact the substrate, and accordingly to cooperate with the fuser member.

Preferably, the fuser base is in the form of a cylindrical roller, with the fuser member correspondingly in the form of a roller specifically, a fuser roller. Also, as a matter of preference, the support member comprises a backup roller.

Further in the toner fusing system and process of the invention, internal heating and/or external heating may be employed. Heating means as are known in the art, such as appropriate heating members, are suitable. Preferably, the means of providing heat for fusing toner and substrate comprise the heating of the fuser member by one or more external and/or internal heating sources by one or more heating members and transmission of this heat from the fuser member to the toner, or to both toner and substrate preferably by contact.

As used herein with reference to heating, the terms “external” and “internal” pertain to positioning with respect to the fuser base. In this regard, “external” indicates location outside of the fuser base, and “internal” means residence within the fuser base.

Correspondingly, an external heating member is outside the fuser member, and therefore outside the fuser base. It provides heat to the fusing surface layer from outside the fuser member.

Consistent with the foregoing, an internal heating member is inside the fuser base, and correspondingly inside the fuser member. It accordingly provides heat to the fusing surface layer from within the fuser member.

Further as to the matter of heating, the term “primary” refers to providing more than 50%, and up to and including 100%, of the heat energy employed for fusing toner to the substrate on which it resides. Correspondingly, the term “secondary” refers to providing less than 50% of the heat energy.

Where there are one or more materials and/or layers, including one or more cushion layers, interposed between the fuser base and the fusing surface layer, they may be those as are known in the art. Where there is at least one cushion layer, the at least one cushion layer can include one or more thermally conductive cushion layers and/or one or more thermally nonconductive cushion layers. Generally, the thickness of the at least one cushion layer is about 20 millimeters or less, preferably from about 1 to about 10 millimeters.

Among the materials which can be used for the cushion layer are suitable silicone elastomers, such as appropriate thermally conductive silicone elastomers and thermally nonconductive silicone elastomers. Addition cure, condensation cure, and peroxide cure silicone elastomers can all be used, with addition cure silicone elastomers and condensation cure silicone elastomers being preferred.

Further, silicone elastomers formulated as liquid injection moldable (LIM), high temperature vulcanizate (HTV), and RTV silicone elastomers can be used. RTV and LIM silicones are preferred. Two particular silicone elastomers which may be used are Silastic™ J silicone and EC4952 silicone.

In a process that may be used for application of the cushion layer, the fuser base optionally can first be degreased and surface roughened. These functions may be accomplished by grit blasting. Except as discussed otherwise herein, the fuser base surface, whether or not initially degreased and roughened, is primed with conventional primer, such as Dow™ 1200 RTV Prime Coat Primer, from Dow Corning Corporation, and material for forming a cushion is subsequently applied thereto.

To form a silicone cushion layer, silicone elastomer is molded, particularly by injection, or extruded or cast onto the fuser base to the desired thickness. Curing is then effected. For a RTV silicone, this is accomplished by allowing it to sit at room temperature.

After curing, conventionally the silicone layer is subjected to a post cure, which improves compression set resistance. Typically a post cure is conducted at a temperature of around 150° C.-240° C., for a period of about 1-48 hours.

Each silicone cushion layer is subjected to cure, and preferably to post cure before application of the next layer, except possibly in the case of the last silicone cushion layer to be laid down. Specifically, for preparation of the fusing surface layer, the curable elastomer containing the surface treated fluoroparticles, as well as any filler, additives, adjuvants, or other materials being employed is laid down on the indicated last applied cushion layer.

If heating is required for the curing of this fusing surface layer material e.g., for curing the curable elastomer containing the surface treated fluoroparticles, then the post cure of the last applied silicone cushion layer may be avoided prior to application of the fusing surface layer material; rather, the heat curing of the fusing surface layer serves as the post cure for the silicone cushion layer on which it is deposited.

Delaying the post cure of the last cushion layer in this manner allows maximum adhesion between the cushion and the fusing surface layer to develop. However, if curing of the fusing surface layer is affected without heat, then the last applied silicone cushion layer is subjected to post cure before the fusing surface layer material is laid down.

Before the fusing surface layer material is applied, the cushion material can be ground to a desired profile, depending upon the paper handling concerns to be addressed. For instance, a cylinder shape, or a crown, or barrel, or bow tie, or hourglass profile may be provided.

For preparation of the fusing surface layer, the fusing surface layer material is laid down either directly on the fuser base or on interposing material as indicated. This material is applied by any suitable means, as are known in the art, to form a layer of the requisite thickness, and then curing is effected also by any suitable means, as are known in the art.

There are factors to consider as to preferred maximum fusing surface layer thicknesses in various circumstances. For instance, if internal heating is employed in the fusing process, then the fusing surface layer must not be so thick as to impede heat transfer impermissibly, and thereby cause the base or core temperature to become excessive. Accordingly, even where the fusing surface layer is directly adjacent to the base, the layer preferably is not thicker than about 2,500 microns.

Where external heating is employed and there is no internal heating, then the fusing surface layer can be thicker. In these circumstances the fusing surface layer can be as thick as about 15,000 microns, or even thicker; theoretically there is no thickness upper limit subject to considerations of cost and processing limitations.

Minimum thickness is also a matter to be considered. As one point, insufficient thickness of the fusing surface layer results in problems with respect to wearability. Wear can be caused by substrate edges, especially where the substrate is paper, and also can result from the scrubbing of the fusing surface layer by the substrate. Wear by substrate edges is a particular problem where a variety of sizes of substrates are used because the edge of a smaller substrate can impart a surface defect or groove that may be visible within the toner receiving region of a larger substrate overlaying the defect or groove.

In low gloss applications, edge wear defects usually are not visible until the depth of the defect reaches about 3 to 8 mils (about 36 to 203 microns) in depth. If the fusing surface layer is thinner than the depth of the defect, then the underlying fuser base or cushion will be exposed, resulting in fuser member failure. Failure will also result if scrubbing by the substrate penetrates the fusing surface layer. For high gloss applications, any loss of gloss may cause a failure, so layer thickness in limited by the integrity of the layer. Layer thickness below 15 microns is typically insufficient to resist paper abrasion without a rigid support layer.

The fusing surface layer, therefore, preferably has a thickness of at least about 15 microns, more preferably of at least about 35 microns, and still more preferably of at least about 45 microns. In a preferred embodiment, the fusing surface layer has a thickness of from about 15 microns to about 2,500 microns.

The fuser member of the invention can be used in toner fusing systems and processes where, during operation, release agent is applied to the fusing surface layer so that this agent contacts toner on the substrate and can also contact the substrate during the operation of the fuser member. Particularly where the fuser base is a cylindrical roller or an endless belt, the release agent is applied while the base is rotating or the belt is running upstream of the contact area between fuser member and substrate toner.

If employed, release agent preferably is applied so as to form a film on the fusing surface layer. As a matter of particular preference, the release agent is applied so as to form a film that completely covers the fusing surface layer. Also as a matter of preference, during operation of the system the release agent is applied continuously to the fusing surface layer.

Release agents are intended to prohibit, or at least lessen, offset of toner from the substrate to the fusing surface layer. In performing this function, the release agent can form, or participate in the formation of, a barrier or film that releases the toner. Thereby the toner is inhibited in its contacting of, or even prevented from contacting the actual fusing surface layer.

The release agent can be a fluid such as an oil or a liquid and is preferably an oil. It can be a solid or a liquid at ambient temperature and a fluid at operating temperatures. Preferred release agents are those that cause minimal swell of the fuser member elastomer layer.

The preferred release agent is a polymeric release agent i.e., a silicone a polyorganosiloxane, and particularly a polydimethylsiloxane. As a matter of particular preference, the release agent is a silicone or polyorganosiloxane or polydimethylsiloxane oil.

Preferably, the silicone or polyorganosiloxane or polydimethylsiloxane release agents have a viscosity at ambient temperature of between about 50 cSt, to about 100,000 cSt.

Suitable release agents are those disclosed in U.S. Pat. Nos. 5,824,416; 4,515,884 and 5,780,545. These three patents are incorporated herein in their entirefies by reference thereto.

Commercially available polydimethylsiloxanes which may be used as release agents are the DC200™ polydimethylsiloxanes, from Dow Corning Corporation.

Also suitable are hydrocarbon release agents, particularly polyethylene release agents. Polyethylene release agents which may be used include those that are solid at 25° C., but liquid at operating temperatures, particularly fusing process temperatures. Preferred polyethylenes are those having a molecular weight of from about 300 to about 10,000.

Yet additionally suitable are perfluoropolyether release agents. Commercially available perfluoropolyethers that are suitable for use as release agents include the following: Krytox, from E.I. du Pont de Nemours and Company, Deepwater, N.J.; Fomblin™ Y45, YR, and YPL1500, from Ausimont USA, Inc., Thorofare, N.J.; and Galden™ HT230, HT250, HT270, also from Ausimont USA, Inc.

Further, release agents which may be used include polymeric release agents having functional groups. Appropriate polymeric release agents with functional groups include those that may be found as liquids or solids at room temperature, but are fluid at operating temperatures.

Particular functional group polymeric release agents which may be used include those disclosed in U.S. Pat. Nos. 4,011,362; 4,046,795 and 5,781,840; these patents also are incorporated herein in their entireties by reference thereto. Still further release agents which may be used are the mercaptofunctional polyorganosiloxanes disclosed in U.S. Pat. No. 4,029,827, and the polymeric release agents having functional groups such as carboxy, hydroxy, epoxy, amino, isocyanate, thioether, and mercaptofunctional groups, as disclosed in U.S. Pat. Nos. 4,101,686 and 4,185,140; yet additionally these patents are incorporated herein in their entireties, by reference thereto.

The more preferred release agents with functional groups are the mercaptofunctional polyorganosiloxane release agents and the aminofunctional polyorganosiloxane release agents. Particularly preferred are the release agents, including mercaptofunctional polyorganosiloxane release agents, comprising monomercaptofunctional polyorganosiloxanes, or polyorganosiloxanes having one mercaptofunctional group per molecule or polymer chain. Also particularly preferred are release agents, including aminofunctional polyorganosiloxane release agents, comprising monoaminofunctional polyorganosiloxanes, or polyorganosiloxanes having one amino functional group per molecule or polymer chain. In this regard, the release agents disclosed in U.S. Pat. Nos. 5,531,813 and 6,011,946 may be used; these patents are incorporated herein in their entireties, by reference thereto.

Further with regard to the functional agents, one point to consider is that because of their expense usually they are diluted with nonfunctional polyorganosiloxanes, particularly nonfunctional polydimethylsiloxanes. Another point is that for obtaining good release activity with a functional release agent, monofunctionality is preferred, so that the molecule cannot react both with toner and with the fusing surface layer and thereby serve as a toner/fuser member adhesive. Therefore, ideally the monofunctional molecule would comprise a substantial portion of the functional agent.

In fact, the functional polyorganosiloxane preferably comprises as great a proportion of the monofunctional moiety as is practically possible. As a matter of particular preference, the functional polyorganosiloxane has a sufficient monofunctional proportion so as not to act as the indicated adhesive.

Accordingly, a preferred release agent composition comprises a blend of nonfunctional polyorganosiloxane, particularly nonfunctional polydimethylsiloxane, with amino functional polyorganosiloxane, and the aminofunctional polyorganosiloxane comprises monoaminofunctional polyorganosiloxane. Another preferred release agent composition comprises a blend of nonfunctional polyorganosiloxane, particularly nonfunctional polydimethylsiloxane, with mercaptofunctional polyorganosiloxane, and the mercapto-functional polyorganosiloxane comprises monomercaptofunctional polyorganosiloxane.

The release agent may be applied to the fuser member by any suitable applicator, including sump and delivery roller, jet sprayer, etc. Those means as disclosed in U.S. Pat. Nos. 5,017,432 and 4,257,699 may be employed; the latter of these two patents is incorporated herein in its entirety, by reference thereto. The present invention employs a rotating wick oiler or a donor roller oiler.

A rotating wick oiler comprises a storage compartment for the release agent and a wick for extending into this compartment. During the operation of the toner fusing system of the invention, the wick is situated so as to be in contact with the stored release agent and also with the fusing surface layer of the fuser member; the wick picks up release agent and transfers it to the fuser member.

A donor roller oiler includes two rollers and a metering blade, which can be a rubber, plastic, or metal blade. One roller meters the oil in conjunction with the blade, and the other transfers the oil to the fuser roller. This type of oiler is common in the art, and is frequently used with fuser members having fluoroelastomer fusing surface layers.

The release agent is applied to the substrate, particularly in the case of paper, preferably at a rate of from about 0.1 to about 20 microliters, more preferably at a rate of about 1.0 to about 8 microliters, per 8½″ by 11″ copy. The applicator is adjusted accordingly to apply the release agent at this rate.

### EXPERIMENTAL PROCEDURES

Materials Employed in the Procedures

Viton™ A fluoroelastomer, a copolymer of vinylidene fluoride and hexafluoropropylene.

PTFE (G-580) from AG Fluoropolymers, a division of Asahi Glass Fluoropolymers USA, INC. of Chadds Ford Pa.

PTFE (M-270), approx. 50 microns mean particle diameter, from Shamrock Technologies Inc., Newark, N.J.

PTFE (MP 1100) from DuPont Fluoroproducts of Wilmington Del.

LS4340-103 condensation cure RTV silicone rubber, from Emerson & Cuming ICI.

PS513 α,ω-aminopropyl terminated polydimethylsiloxane, from United Chemical Technologies, Inc., Bristol, Pa.

1,000 centistoke DC200 polydimethylsiloxane, from Dow Corning Corporation.

MgO (Maglite™ Y), from Merck/Calgon Corp., Teterboro, N.J.

Viton™ Curative No. 50, from Dupont Dow Elastomers.

Catalyst 50, from Emerson & Cuming ICI.

Surface Modification of Fluoropolymer Particles

All chemicals in the fluoropolymer particle modification schemes discussed herein below, except where the preparation thereof is specifically described, are available from Sigma Aldrich, Inc. of Milwaukee, Wis. and were used directly as obtained without purification. All fluoropolymer particles were used directly as received. Dimethylformamide (DMF) were distilled from calcium hydride and maintained with 4A molecular sieves. A one-liter photochemical reactor from Ace Glass, equipped with a medium pressure, quartz, mercury-vapor ultraviolet immersion lamp from Hanovia, was employed for the particle modification.

Analysis of x-ray Photoelectron Spectroscopy (XPS) was made using a Surface Science Laboratories Model SSX 100 Photoelectron Spectrometer. This instrument uses monochromatic Al K-alpha X-rays and multichannel electron detection. Powder samples were mounted by carefully filling small aluminum pans and mounting these to the normal XPS instrument sample stub. Samples were placed in the instrument entrance chamber which was pumped to a pressure of less than 1×10-4 torr. The samples were then introduced into the main analysis chamber. Analyses were all performed at vacuum levels of 5×10-8 torr or lower. The sampling depth in XPS measurements is controlled by the electron mean free path (MFP), which is the distance an electron can travel in the material without undergoing an inelastic collision. For polymer materials this distance ranges from 4 to 10 nm from the surface so that XPS measurement only provides the atomic information on the polymer surface.

### EXAMPLE 1

Benzophenone (10.93 grams) was dissolved into 500 ml of dry DMF in a 1000 ml flask. Sodium hydride (5.21 grams) was added to the solution to form a white suspension. The PTFE powder of MP1100 (100 grams) was added to the suspension slowly with severe stirring. Transfer the mixture into photochemical reactor and then purge it with nitrogen to make the suspension turbulent. Turn on the immersion UV lamp after 30 minutes of nitrogen purging. The mixture becomes dark brown during the reaction. After 4 hours of reaction under UV light and constant nitrogen flow, the mixture was filtered through glass microfiber and washed with deionized water until the filtrate is neutral. The collected brown particles were rinsed with tetrahydrofuran (THF) and then extracted with THF in a Soxhlet condenser overnight. The extracted particles were dried in a vacuum oven at 50° C. for a day. Combustion analysis indicates the modified powder has 67.8% fluorine, which is significantly lower than the amount of 76.0% in the —CF2-CF2- repeat units in PTFE.

### EXAMPLE 2

The procedure of Example 1 is substantially repeated, except that the modified PTFE particles were rinsed with methyl ethyl ketone, instead of THF. Without Soxhlet extraction, the rinsed particles were directly dried in a vacuum oven at 50° C. for a day. The amount of fluorine is found to be 66.5% by combustion analysis.

### EXAMPLE 3

The procedure of Example 1 is substantially repeated, except that the PTFE powder modified is M270. In addition, the time period of UV light exposure is decreased to one hour. The modified particles are dark brown. Shown in Table 2, analysis of x-ray Photoelectron Spectroscopy (XPS) indicates that the modified particles have reduced fluorine, increased carbon, incorporation of oxygen and nitrogen within the 4-10 nm from the surface. The element ratio of fluorine to carbon significantly decreases to 0.86 from the value of 2 for the untreated PTFE particles (Comparative Example 2).

### EXAMPLE 4

The procedure of Example 1 is substantially repeated, except that FEP particles, instead of PTFE, were treated. The obtained modified particles are grey-brown. XPS results in Table 2 shows that the modified particles have reduced fluorine, increased carbon and incorporation of oxygen as well within 4-10 nm of the surface. The element ratio of fluorine to carbon decreases to 1.0 from the value of 1.8 for the untreated FEP particles (Comparative Example 3).

### COMPARATIVE EXAMPLE 1

The procedure of Example 1 is substantially repeated, except that no UV light was on during the reaction. The color of obtained PTFE particles remains white. The amount of fluorine is found to be 71.2% by combustion analysis.

### COMPARATIVE EXAMPLE 2

The untreated particles of MP1100 were rinsed and then extracted with THF in a Soxhlet condenser overnight. The extracted particles were dried in a vacuum oven at 50° C. for a day. XPS results in Table 2 indicates no other element other than fluorine and carbon was found on the powder surface and the element ratio of fluorine to carbon is approximately 2 as expected for the pure PTFE material.

### COMPARATIVE EXAMPLE 3

The untreated FEP particles were rinsed and then extracted with THF in a Soxhlet condenser overnight. The extracted particles were dried in a vacuum oven at 50° C. for a day. XPS analysis indicates no other element other than fluorine and carbon was found on the powder surface and the element ratio of fluorine to carbon is approximately 2 as expected for the pure PTFE material.

TABLE 1

| | | Bulk % | Surface F/C |
|---|---|---|---|
| | Fluoropolymer | Fluorine | Ratio |
| Ex 1 | PTFE | 67.8 | — |
| Ex 2 | PTFE | 66.5 | — |
| Ex 3 | PTFE | — | .86 |
| Ex 4 | FEP | — | 1.0 |
| CE 1 | PTFE | 71.2 | — |
| CE 2 | PTFE | — | 2.1 |
| CE 3 | FEP | — | 1.8 |

The results of the treatments in Table 1 show a loss of fluorine in the bulk and at the surface. The loss of fluorine at the surface is substantially greater than the bulk, indicating that the treatment is a surface effect. The fluorine content has been reduced by at least 20 percent in Examples 3 and 4 over CE 2 and 3.

Combustion analysis of treated MP1100 PTFE in Example 1 and Example 2 were determined to have 4.77% and 6.6% fluorine loss respectively relative to an untreated control sample. For spherical particles the treatment depth can be estimated if the fluorine loss from the treated layer is complete:
t=r*[(1−C)ˆ⅓−1]
Where
t=treated layer thickness
r=particle radius
C=percent fluorine removed during treatment

Using the preceding equation, the treated layer in Example 1 and 2 is about 1.6 and 2.25 percent of the particle radius respectively, or about 3.2 nm to 4.5 nm respectively. This confirms that the treatment is at the surface.

TABLE 2
XPS results

| | Atomic percentage (%) | | | | Atomic ratio | |
|---|---|---|---|---|---|---|
| Example # | C | F | O | N | F/C | O/C |
| Ex 3 | 48.26 | 41.52 | 6.42 | 2.12 | 0.86 | 0.13 |
| Ex 4 | 45.5 | 50.93 | 3.57 | 0 | 1.1 | 0.08 |
| CE 2 | 31.46 | 68.54 | 0 | 0 | 2.2 | 0 |
| CE 3 | 35.79 | 64.21 | 0 | 0 | 1.8 | 0 |

The XPS results show that the modified particles have reduced fluorine, increased carbon and incorporation of oxygen or nitrogen within the 4-10 nm range from the surface. The element ratios of fluorine to carbon in all surface-modified example surfaces are significantly lower than those comparative examples.

Preparation of Fluoroelastomer Composition

An amount of 400 grams of Viton™ A and 48 grams of Mag-Y were thoroughly compounded on a water-cooled two-roll mill at 63° F. (17° C.). For each composition, compounding was conducted until a uniform, dry composite sheet was obtained. The sheet was removed and stored until used for the preparation of a coating solution. This compound is Compound 1.

### COMPARATIVE EXAMPLE 4

An amount of 25 grams of Compound 1 was dissolved in 98 grams of MEK along with 5.25 grams of M270. The solution was milled in a crock for 18 hours with ceramic media before adding 1.93 grams Cure 50 and 0.2 grams PS513. The solution, having a viscosity of about 150 centipoise, was filtered and coated 2× onto a DHV roller from a Digimaster™ 9110 having a corona surface treatment thereon. The composite was cured at 230° C. for 24 hours after a 12 hour ramp from room temperature.

An abrasion sample was prepared by cutting an axial section, with a width greater than 0.59 inch, from the composite roller then trimmed to a strip 0.59 inch wide and shaved to a uniform thickness of 1500 microns.

The sample for surface abrasion testing was placed on a heated stage and maintained at 175° C. during the test. Surface abrasion was performed using a Norman Abrasion Wear Tester, Norman Tool, Inc., Evansville, Ind., with a 0.69 inch wide strip of test paper for wearing the sample. The test paper was pressed in contact with the sample, and cyclically dragged over the sample by a load arm bearing a 755 gram load, and so applying a total weight of 894 grams to the sample for sufficient wear cycles to generate a groove without tearing the coated layer thereby producing abrasive wear in the form of a wear track.

The depth of the wear track was measured with a Surfanalyzer™ System 4000, from Mahr Federal Inc., Providence, R.I., using a conical stylus under a 250 mg load. The wear rate was calculated in mils of wear track depth per 100 cycles and the result is shown in Table 3.

### EXAMPLE 5

A test sample was prepared substantially the same as Comparative Example 4 except that the M270 was treated as described in Example 3. The results of wear testing are shown in Table 3.

### COMPARATIVE EXAMPLE 5

A test sample was prepared substantially the same as Comparative Example 4 except that the amount of Cure 50 was reduced from 1.93 grams to 1.39 grams. The results of wear testing are shown in Table 2.

### EXAMPLE 6

A test sample was prepared substantially the same as Comparative Example 5 except that the M270 was treated as described in Example 3. The results of wear testing are shown in Table 3.

### COMPARATIVE EXAMPLE 6

A test sample was prepared substantially the same as Comparative Example 4 except that the M270 was replaced by G580. The results of wear testing are shown in Table 3.

### EXAMPLE 7

A test sample was prepared substantially the same as Comparative Example 6 except that the G580 was treated using the method described in Example 3, excepting that the M270 in Example 3 was replaced by G580. The results of wear testing are shown in Table 3.

### COMPARATIVE EXAMPLE 7

A test sample was prepared substantially the same as Comparative Example 7 except that the amount of Cure 50 was increased from 1.39 grams to 1.93 grams. The results of wear testing are shown in Table 3.

### EXAMPLE 8

A test sample was prepared substantially the same as Comparative Example 7 except that the G580 was treated using the method described in Example 3, excepting that the M270 in Example 3 was replaced by G580. The results of wear testing are shown in Table 3.

The wear rate results in Table 3 show that in every case the treated PTFE filler has a lower wear than the untreated material. This is particularly true when the curative level in the layer is reduced. Lower curative levels are desirable for longer solution life that simplifies handling the coating materials.

TABLE 3

| | | | Cure level | Wear Rate |
|---|---|---|---|---|
| | PTFE | | (parts per 100 | (mils/100 |
| Example | Type | Treatment | parts viton A) | cycles) |
| Comparative Example 4 | M270 | none | 6.9 | 1.34 |
| Example 5 | M270 | Y | 6.9 | 1.12 |
| Comparative Example 5 | M270 | none | 5 | 1.72, 2.16 |
| Example 6 | M270 | Y | 5 | 0.83, 1.22 |
| Comparative Example 6 | G580 | none | 6.9 | .83 |
| Example 7 | G580 | Y | 6.9 | .77 |
| Comparative Example 7 | G580 | none | 5 | 1.92 |
| Example 8 | G580 | Y | 5 | 1.11 |

### COMPARATIVE EXAMPLE 8

An amount of 5 grams of silicone (LS4340-103) was combined with 10 grams of MP1100 and 35 grams of MEK. The solutions were milled for 48 hours in ajar with ceramic milling media. An amount of 0.025 grams of Catalyst 50 was added and the solution was coated twice onto a fuser roller after degassing under vacuum. The composite was cured at 218 C for 24 hours and cooled. A wear test sample was prepared as described in Comparative Example 4, and the results are shown in Table 4.

### EXAMPLE 9

A test sample was prepared substantially the same as Comparative Example 8 except that the MP1100 was treated as described in Example 1. The wear results are shown in Table 4.

### COMPARATIVE EXAMPLE 9

A test sample was prepared substantially the same as Comparative Example 8 except the amount of silicone was increased to 10 grams and the amount of MP1100 was reduced to 5 grams. The amount of MEK was also reduced to about 20 grams. The wear results are shown in Table 4.

### EXAMPLE 10

A test sample was prepared substantially the same as Comparative Example 9 except that the MP1100 was treated as described in Example 1. The wear results are shown in Table 4.

TABLE 4

| | PTFE Level | | Wear Rate |
|---|---|---|---|
| | (parts per 100 | | (mils per 100 |
| Example | parts silicone | Treatment | cycles) |
| Comparative | 200 | None | 4.8 |
| Example 8 | | | |
| Example 9 | 200 | Yes | 3.92 |
| Comparative | 50 | None | 3.85 |
| Example 9 | | | |
| Example 10 | 50 | Yes | 2.5 |

The results in Table 4 demonstrate improved wear in silicone materials when the surface treatment is employed.

Release Testing

To evaluate release performance, one inch square sample was cut from the composite roller coatings and dampened with a small amount of 1000 cSt silicone fluid. The excess fluid was removed and a Polyester toner applied to one sample. A comparison sample is placed on a heated (205° C.) plate for 10 minutes. The toner-coated sample is placed on top of the comparison sample such that the toner is sandwiched between, and a load applied. After 1 minute the samples are parted and the amount of toner transferred to the comparison sample rated. The ratings are from 1 to 5, where 1 indicates no toner transfer and 5 indicates 100 percent toner transfer.

TABLE 5

| | | Transfer to |
|---|---|---|
| | | Comparison |
| Sample | Comparison Sample | Sample |
| Comparative Example 8 | Example 9 | 2, 2 |
| Example 9 | Comparative Example 8 | 5, 5 |
| Comparative Example 9 | Example 10 | 1.5, 2 |
| Example 10 | Comparative Example 9 | 5, 5 |

The results in Table 5 show that toner is consistently transferred to the untreated samples (from the treated samples), while toner is not transferred to the treated samples (and remains with the untreated samples). This demonstrates that silicone formulations using the surface treatment have superior release qualities compared to formulations using untreated PTFE.

The invention has been described in detail with particular reference to certain preferred embodiments thereof, but it will be understood that variations and modifications can be effected within the spirit and scope of the invention.

What is claimed:

1. A coating for a fuser roller comprising:
an elastomer layer; and
fluoroplastic particles dispersed through the elastomer layer wherein a surface of said particles has been contacted with a solution comprising a group I or a group II metal hydride while being exposed to UV radiation.

2. The coating of claim 1, wherein the elastomer layer comprises a fluoroelastomer.

3. The coating of claim 2, wherein the fluoroelastomer is formed from monomers selected from the group consisting of vinylidene fluoride, hexafluoropropylene, tetra-fluoroethylene, perfluorovinylmethyl ether, and ethylene [—(CH2CH2)—].

4. The coating of claim 2, wherein the fluoroelastomer comprises random polymers comprising the following monomeric units:
—(CH2CF2)x-, —(CF2CF(CF3))y-, and —(CF2CF2)z-,
wherein;
x is from about 30 to about 90 mole percent,
y is from about 10 to about 60 mole percent, and
z is from about 0 to about 42 mole percent.

5. The coating of claim 2, wherein the fluoroelastomer comprises random polymers comprising the following monomeric units:
—(CH2CF2)x-, —(CF2CF(OCF3))y-, and —(CF2CF2)z-,
wherein
x is from about 0 to about 70 mole percent,
y is from about 10 to about 60 mole percent, and
z is from about 30 to about 90 mole percent

6. The coating of claim 1, wherein the elastomer comprises silicone elastomers.

7. The coating of claim 6, wherein the silicone elastomers comprise polydimethylsiloxane, poly(dimethyldiphenyl)siloxane, and polymethyl-3,3,3-trifluoropropylsiloxane.

8. The coating layer of claim 1, wherein the fluoroplastic particles are from 0.1 to 80 microns.

9. A fuser member comprising:
a base;
a surface layer comprising:
an elastomer layer and
fluoroplastic particles dispersed through the elastomer wherein a surface of said particles has been contacted with a solution comprising a group I or a group II metal hydride.

10. A coating for a fuser roller comprising:
an elastomer layer
fluoroplastic particles dispersed through the elastomer wherein a ratio of carbon to fluorine atoms at a surface of said particles has been reduced by 20 percent.

11. The coating of claim 10 wherein the fluoroplastic particles comprise polytetrafluoroethylenes or fluorinated ethylene propylenes.

12. The coating layer of claim 10, wherein the fluoroplastic particle are from 0.1 to 80 microns.

13. The coating of claim 10, wherein the elastomer layer comprises a fluoroelastomer.

14. The coating of claim 13, wherein the fluoroelastomer is formed from monomers selected from the group consisting of vinylidene fluoride, hexafluoropropylene, tetra-fluoroethylene, perfluorovinylmethyl ether, and ethylene [—(CH2CH2)—].

15. A coating for a fuser roller comprising:
an elastomer layer
fluoroplastic particles dispersed through the elastomer wherein a surface of said particles has an oxygen concentration greater than zero.

16. The coating of claim 15 wherein the fluoroplastic particles comprise polytetrafluoroethylenes or fluorinated ethylene propylenes.

17. The coating layer of claim 15, wherein the fluoroplastic particle are from 0.1 to 80 microns.

18. The coating of claim 15, wherein the elastomer layer comprises a fluoroelastomer.

19. The coating of claim 18, wherein the fluoroelastomer is formed from monomers selected from the group consisting of vinylidene fluoride, hexafluoropropylene, tetra-fluoroethylene, perfluorovinylmethyl ether, and ethylene [—(CH2CH2)—].

20. A method for treating fluoroplastic particulates comprising:
dispersing the particulates in a solvent containing a UV absorber and a group 1 metal hydride;
exposing the solution to UV light through a UV transparent surface; and
agitating the solution such that the particles are uniformly treated at the UV transparent surface.
